(19) United States
(12) Patent Application Publication
(10) Pub. No.: US 2009/0278458 A1
(43) Pub. Date: Nov. 12, 2009

(54) OUTDOOR LIGHTING DEVICE

(75) Inventor: GA-LANE CHEN, Santa Clara, CA (US)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/257,768

(22) Filed: Oct. 24, 2008

(30) Foreign Application Priority Data
May 6, 2008 (CN) 200810301421.2

(51) Int. Cl. H05B 41/00

(52) U.S. Cl. 315/87

(57) ABSTRACT

An outdoor lighting device includes first and second LED arrays, first and second electric power supply systems, and a heat conducting substrate for the second electric power supply system. The first LED array works when natural wind blows. The first electric power supply system includes a fan and an electric power generator. The electric power generator is mechanically connected to the fan and configured for converting the kinetic energy of the fan into electric power for the first LED array. The second LED array works when the first LED array does not work. The second electric power supply system includes a solar cell panel for converting solar energy into electric power for the second LED array. The solar cell panel is arranged above the heat conducting substrate, and a space exists between the solar cell panel and the heat conducting substrate, thereby facilitating heat dissipation of the heat conducting substrate.

### CROSS-REFERENCE TO RELATED APPLICATIONS

This application is related to a commonly-assigned co-pending application entitled, “OUTDOOR LIGHTING DEVICE”, filed on Sep. 2, 2008 (U.S. application Ser. No. 12/202588, Docket No. US18948). Disclosures of the above identified application is incorporated herein by reference.

### BACKGROUND

1. Technical Field

The present invention relates to lighting devices and, particularly, to an outdoor lighting device with LED arrays.

2. Description of Related Art

Light emitting diode (LED), a solid state light emitting element, has been widely used in lighting.

An LED is capable of producing a visible light in a certain wavelength if an electric power is applied to the LED. However, 80% to 90% of the electrical energy consumed by the LED is converted to heat, which needs to be dissipated, and only the small remainder is converted to the light.

When a plurality of LEDs, such as an LED array is used at outdoors, it is usually difficult to power the LED array and dissipate heat for it.

What is needed, therefore, is an outdoor lighting device, which overcomes the above problems.

### SUMMARY

An outdoor lighting device includes a first LED array, a second LED array, a first electric power supply system, a heat conducting substrate and a second electric power supply system. The first LED array is capable of working at a first time when a natural wind blows. The first electric power supply system includes a fan and an electric power generator. The electric power generator is mechanically connected to the fan and configured for converting the kinetic energy of the fan into electric power for the first LED array. The second LED array is arranged adjacent to the first LED array. The second LED array is capable of working at a second time when the first LED array does not work. The heat conducting substrate is attached on the second LED array. The second electric power supply system includes a solar cell panel for converting solar energy into electric power for the second LED array. The solar cell panel is arranged above the heat conducting substrate, and a space exists between the solar cell panel and the heat conducting substrate so as to facilitate heat dissipation of the heat conducting substrate.

Other novel features and advantages of the present outdoor lighting device will become more apparent from the following detailed description of embodiments when taken in conjunction with the accompanying drawings.

### BRIEF DESCRIPTION OF THE DRAWINGS

Many aspects of the outdoor lighting device can be better understood with reference to the following drawings. The components in the drawings are not necessarily drawn to scale, the emphasis instead being placed upon clearly illustrating the principles of the present outdoor lighting device. Moreover, in the drawings, like reference numerals designate corresponding parts throughout the several views.

FIG. 1 is a schematic view of an outdoor lighting device in accordance with an exemplary embodiment.

FIG. 2 is a block diagram showing electrical connections among an electric power generator, a first control unit, a first battery pack and a first LED array of FIG. 1.

FIG. 3 is a block diagram showing electrical connections among a solar cell panel, a second control unit, a second battery pack and a second LED array of FIG. 1.

### DETAILED DESCRIPTION OF THE EMBODIMENTS

Embodiments of the present outdoor lighting device will now be described in detail below and with reference to the drawings.

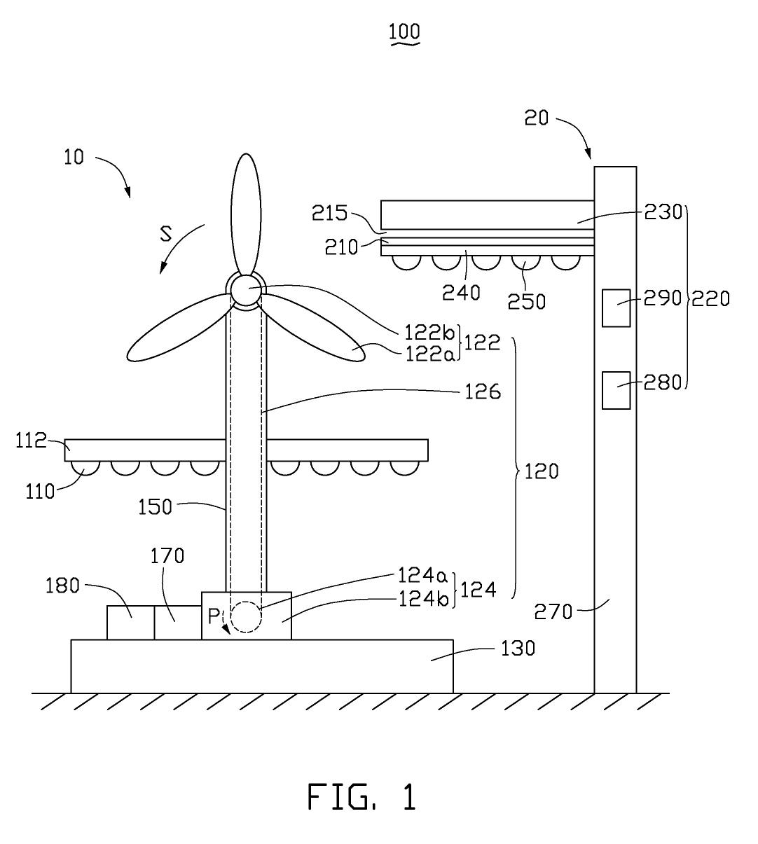

Referring to FIG. 1, an outdoor lighting device 100 in accordance with an exemplary embodiment, is provided. The outdoor lighting device 100 includes a first lighting device 10 and a second lighting device 20. The first lighting device 10 mainly includes a first LED array 110 and a first electric power supply system 120. The second lighting device 20 mainly includes a second LED array 250, a heat conducting substrate 210 and a second electric power supply system 220. The first LED array 110 is arranged for working at a first time when a natural wind blows. The second LED array 250 is arranged for working at a second time when the first LED array 110 does not work.

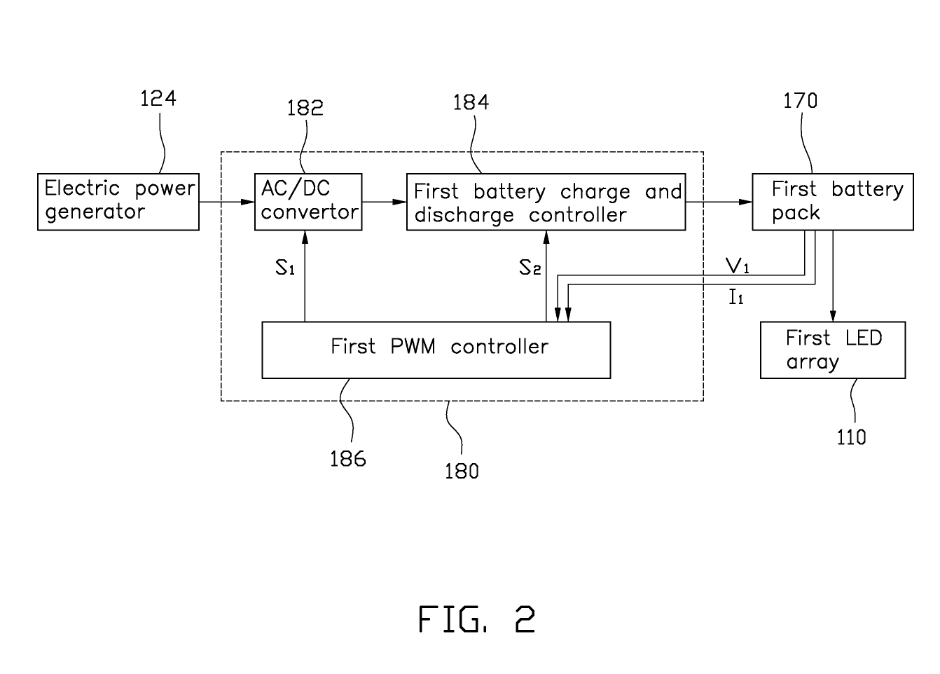

The first LED array 110 is arranged on a printed circuit board (PCB) 112 and faces the ground. The first electric power supply system 120 mainly includes a fan 122 and an electric power generator 124. In addition, a first battery pack 170 (see FIG. 2) and a first control unit 180 are provided to connect the electric power generator 124 to the first LED array 110.

A base 130 and a first elongated post 150 are also included in the first electric power supply system 120. The electric power generator 124, the first elongated post 150, the first battery pack 170 and the first control unit 180 are arranged on the base 130. The fan 122 includes a shaft 122b and three blades 122a attached on the shaft 122b. The fan 122 is mounted at an end of the first elongated post 150 opposite from the base 130. The first LED array 110 is also mounted on the first elongated post 150, between the fan 122 and the base 130.

The electric power generator 124 includes a rotator 124a and a stator 124b. The rotator 124a is mechanically connected to the shaft 122b of the fan 122 by a connection belt 126. Once a natural wind blows, the blades 122a will be blew to rotate, e.g., in a direction as the arrowhead S shows, then the shaft 122b will thus be rotated, and the rotator 124a is driven to rotate in a direction as the arrowhead P shows. The stator 124b generates an electric power when the rotator 124a rotates.

Referring to FIG. 2, a block diagram showing electrical connections among the electric power generator 124, the first control unit 180, the first battery pack 170 and the first LED array 110, is provided. The first control unit 180 is configured for controlling the electric power generator 124 to charge the first battery pack 170 and controlling the first battery pack 170 to power the first LED array 110. The first control unit 180 includes an alternating current/direct current (AC/DC) converter 182, a first battery charge and discharge controller 184 and a first pulse width modulation (PWM) controller 186. The AC/DC converter 182 is connected to the electric power generator 124. The first battery charge and discharge controller 184 is connected to the AC/DC converter 182 and the first battery pack 170. The first PMW controller 186 is connected to the AC/DC converter 182, the first battery charge and discharge controller 184 and the first battery pack 170. The AC/DC converter 182 is configured for converting an alternating current generated by the electric power generator 124 into a direct current that the battery pack 170 can receive.

When a natural wind blows, the first PMW controller 186 first obtains a voltage signal V₁ and a current signal I₁ of the first battery pack 170, then outputs a charge signal S₁ to activate the AC/DC converter 182 to work. The AC/DC converter 182 then can outputs a direct current to the first battery pack 170 via the first battery charge and discharge controller 184. The first PMW controller 186 outputs a discharge signal S₂ to the first battery charge and discharge controller 184, the first battery charge and discharge controller 184 then controls the first battery pack 170 to power the first LED array 110.

When the natural wind disappears, the first LED array 110 will be powered off. In this way, the first LED array 110 works only at the time when the natural wind blows, such that heat generated by the first LED array 110 can be dissipated timely by the natural wind.

The second LED array 250 and the second electric power supply system 220 are mounted on a second elongated post 270. The second elongated post 270 is taller than the first elongated post 150 and is arranged adjacent to the first elongated post 150. The second LED array 250 is mounted on a second PCB 240. Light emitted from the second LED array 250 can project on the ground. The second LED array 250 is arranged over the first LED array 110 and adjacent to the fan 122. The heat conducting substrate 210 is attached on the second PCB 240.

The second electric power supply system 220 mainly includes a solar cell panel 230, a second control unit 280 and a second battery pack 290. The solar cell panel 230 is arranged above the heat conducting substrate 210, and a space 215 exists between the solar cell panel 230 and the heat conducting substrate 210, such that the heat conducting substrate 210 will not be heated by the sunlight, and thus facilitating heat dissipation of the heat conducting substrate 210.

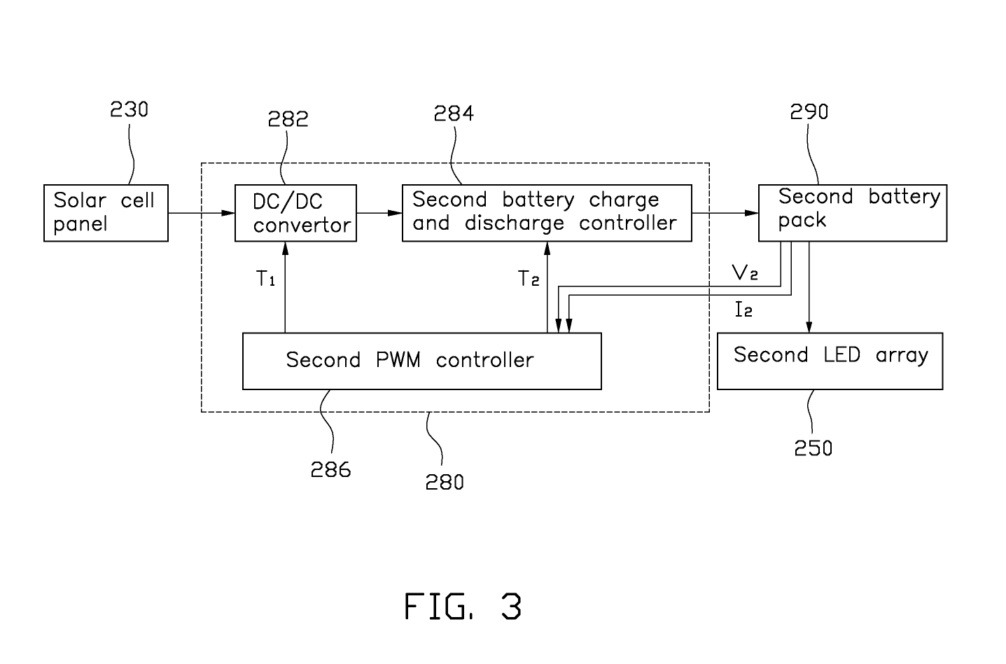

Referring to FIG. 3, a block diagram showing electrical connections among the solar cell panel 230, the second control unit 280, the second battery pack 290 and the second LED array 250, is provided. The second control unit 280 is configured for controlling the solar cell panel 230 to charge the second battery pack 290 and controlling the second battery pack 290 to power the second LED array 250. Electrical wires can be arranged in the second elongated post 270. The second control unit 280 includes a DC/DC converter 282 connected to the solar cell panel 230, a second battery charge and discharge controller 284 connected to the DC/DC converter 282 and the second battery pack 290, and a second pulse width modulation controller (PWM) 286. The DC/DC converter 282 is configured for converting a direct current from the solar cell panel 230 to anther direct current that the second battery pack 290 can receive. When sunlight exists, the second PWM controller 286 can obtain a voltage signal V₂ and a current signal I₂ from the second battery pack 290, and can output a charge signal T₁ to activate the DC/DC converter 282 to work, then the second battery charge and discharge controller 284 can control the solar cell panel 230 to charge the second battery pack 290. When the first LED array 110 is powered off, the second PWM controller 286 will output a discharge signal T₂ to the second battery charge and discharge controller 284, the second battery charge and discharge controller 284 then can control the second battery pack 290 to power the second LED array 250.

In this way, the first LED array 110 and the second LED array 250 work at a different time, the second lighting device 20 can compensate for the first lighting device 10. Heat dissipation and electric power for each of the first LED array 110 and the second LED array 250 are carried out at the same time. The entire outdoor lighting device 100 is environmental friendly and can function effectively.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. An outdoor lighting device, comprising:
a first LED array capable of working at a first time when a natural wind blows;
a first electric power supply system comprising a fan, and an electric power generator mechanically connected to the fan and configured for converting the kinetic energy of the fan into electric power for the first LED array;
a second LED array arranged adjacent to the first LED array, the second LED array being capable of working at a second time when the first LED array does not work;
a heat conducting substrate attached on the second LED array; and
a second electric power supply system comprising a solar cell panel for converting solar energy into electric power for the second LED array, the solar cell panel being arranged above the heat conducting substrate, and a space existing between the solar cell panel and the heat conducting substrate so as to facilitate heat dissipation of the heat conducting substrate.

2. The outdoor lighting device of claim 1, wherein the first electric power supply system further comprises a first elongated post, the first LED array and the fan being mounted on the first elongated post, the fan being arranged at an end of the first elongated post.

3. The outdoor lighting device of claim 2, wherein the second electric power supply system further comprises a second elongated post, the second LED array and the solar cell panel being mounted on an end of the second elongated post, the second elongated post being taller than the first elongated post and arranged beside the first elongated post.

4. The outdoor lighting device of claim 1, wherein the first electric power supply system further comprises a first battery pack and a first control unit, the electric power generator is connected to the first battery pack by the first control unit, the first control unit is configured for controlling the electric power generator to charge the first battery pack and controlling the first battery pack to power the first LED array.

5. The outdoor lighting device of claim 4, wherein the first control unit comprises an AC/DC converter connected to the electric power generator, a first battery charge and discharge controller connected to the AC/DC converter and the first battery pack, and a first pulse width modulation controller connected to the AC/DC converter, the first battery charge and discharge controller and the first battery pack.

6. The outdoor lighting device of claim 1, wherein the second electric power supply system further comprises a second battery pack and a second control unit, the solar cell panel connected to the second battery pack by the second control unit, the second control unit configured for controlling the solar cell panel to charge the second battery pack and controlling the second battery pack to power the second LED array.

7. The outdoor lighting device of claim 6, wherein the first control unit comprises a DC/DC converter connected to the solar cell panel, a second battery charge and discharge controller connected to the DC/DC converter and the second battery pack, and a second pulse width modulation controller connected to the DC/DC converter, the second battery charge and discharge controller and the second battery pack.

8. The outdoor lighting device of claim 1, wherein the electric power generator comprises a rotator and a stator, the rotator is mechanically connected to the fan and driven to rotate by the fan, the stator is electrically connected to the first battery pack.

9. The outdoor lighting device of claim 1, wherein the first electric power supply system further comprises a base, the first elongated post and the electric power generator are arranged on the base.
